(19) United States
(12) Patent Application Publication
(10) Pub. No.: US 2024/0255012 A1
(43) Pub. Date: Aug. 1, 2024

(54) Blind wand holder

(71) Applicant: Ryan Durocher, Placentia, CA (US)

(72) Inventor: Ryan Durocher, Placentia, CA (US)

(21) Appl. No.: 18/101,859

(22) Filed: Jan. 26, 2023

(51) Int. Cl. F16B 2/22; E06B 9/303; E06B 9/38

(52) U.S. Cl. CPC F16B 2/22; E06B 9/303; E06B 9/38

(57) ABSTRACT

This invention includes embodiments of a clip for use with an adjustable slat blind. The clip may include a compliant body, a first recess, a second recess, and an expansion feature. In other embodiments, the invention includes a clip for use with a blind that includes a magnetic link. The clip includes a body that defines a first aperture that is sized to retain the wand of a blind. The clip also includes a second body that has a second aperture sized to retain a slat of the blind. The magnetic link couples the first body to the second body.

### TECHNICAL FIELD

This invention relates to window blinds and accessories for window blinds. It includes devices to immobilize the slat adjusting wand of such blinds.

### BACKGROUND ART

Window blinds with angularly adjustable slats, sometimes identified as venetian blinds or miniblinds, include a plurality of horizontally arranged slats supported by cords or frames. The slats are generally planar, though they may be curved, folded, or creased for added strength. Blinds allow a user to adjust the angle of the slats. The adjustment range extends from a fully open position (with slats disposed perpendicular to the window surface) to fully closed (with slats disposed substantially parallel to the window surface). In the open position, the slats allow close to an unobstructed view through the window because the slats are thin with respect to their width, and a user views them edge on. In the closed positions, slats align or overlap to block most light and ventilation from the window.

Slats are generally supported by ladder cords or by rigid uprights at one or more locations depending on the size of the blinds. When ladder cords are used, the ladder cords depend from a mounting assembly, which is generally affixed to a sill, a wall, or a ceiling above the window. Ladder cords usually include at least two vertically disposed parallel cords with a plurality of cross cords connecting the parallel cords at selected intervals. The assembly resembles a ladder with the parallel cords forming the uprights and the cross cords forming the steps. Typically, a blind contains several ladder cords so that the slats may be supported across the full width of the blind.

Each cross cord step in a ladder cord supports a slat with each of the slats suspended by the parallel cords and resting on the cross cords. Adjustment of the relative height of the parallel cords in a ladder cord changes the angle of each of the cross cords. The slats generally rest passively on the cross cords and alter their angle with respect to the window surface as the relative height of the parallel cords in a ladder cord changes.

Since the ladder cords usually originate from a mounting assembly disposed at or near the top of the blinds, which may be difficult for a user to reach, blinds usually include an elongated adjusting wand connected to the mounting assembly and depending downwards. The distal end of the wand (away from the mounting frame) is unconnected so that the wand dangles freely. A common method of adjusting the relative height of the parallel cords (and hence the angle of the slats with respect to the window) is to rotate the wand with respect to its long axis. A mechanism in the mounting assembly translates this rotation into changes in the relative height of the parallel cords.

Although the wand arrangement as described above has clear advantages of adjustability with minimal effort, it also produces problems. In particular, breezes from an open window or indoor fan can cause the relatively light wand to blow about, making an objectionable noise and stressing the mechanical parts. The freely moving wand may also be a hazard as it could swing to eye level and cause injury.

It is possible to anchor the free end of the wand to a surface such as a wall or sill (as illustrated at https://www.thingiverse.com/thing: 1316352 accessed 10-06-2022), but this has a further disadvantage of requiring installation steps that may be too difficult for some users or may cause damage to the surfaces of the dwelling. Such an anchor may also deflect the wand to a less accessible position, particularly when the blind is installed within a recessed window sill.

There is thus a need to for a device to anchor an adjustment wand of a blind without attaching to a surface of a wall or sill.

### Disclosure of Invention/Summary

In some embodiments, the invention includes a clip for use with an adjustable slat blind. The blind has a ladder cord and an elongated wand that adjusts a position of a slat. The clip includes a compliant body, a first recess, a second recess, and an expansion feature. The first recess is defined within the compliant body and retains a wand of the blind. The second recess is also defined within the compliant body and retains a ladder cord of the blind. Application of a force to the expansion feature expands the first recess so that the wand may enter the first recess. Release of the force lets the compliant body recover so that the wand is retained in the first recess.

The wand may be free to rotate when retained within the first recess. The first recess may be contiguous with the second recess. The first recess may have an inside diameter larger than the outside diameter of the wand.

In other embodiments, the invention includes a clip for use with a blind. The blind includes one or more slats, one or more ladder cords, and an elongated wand that adjusts an angle of the slats. The clip includes a first body, a second body, and a magnetic link. The first body includes a first aperture, which is sized to retain the wand of a blind. The second body includes a second aperture sized to retain a slat of the blind. The magnetic link couples the first body to the second body. The first body and the second body may be separable. Portions of the magnetic link may be permanently affixed to the first body or the second body.

In some embodiments, the inside diameter of the first aperture may be larger than the outside diameter of the wand so that the wand is free to rotate when retained within the first aperture.

In embodiments, the magnetic link may be formed as two parts: a ball and a roller. The ball may have a circular cross section and may be affixed to the first body. The ball and the roller comprise magnetic materials that produce a force that holds the ball in contact with the roller.

The roller may have a circular cross section and may be affixed to the second body. In some embodiments, the ball may be approximately spherical, and the roller may be approximately cylindrical so that the ball and the roller can change their relative orientation while remaining in contact. Adjustment of the angle of the slat causes the ball to move with respect to the roller.

In other embodiments, the invention includes a blind that has a support, a ladder cord, a slat, a wand, and a clip. The ladder cord depends from the support and includes two vertical cords and one or more cross cords. The vertical cords are parallel to one another and usually are disposed from top to bottom of the blind when the blind is installed. The cross cord connects the first vertical cord to the second vertical cord. The slat is supported by the ladder cord. The elongated wand has a mounted end depending from the support. The wand designed to alter the relative position of the first vertical cord with respect to the second vertical cord by rotation of the wand. The clip connects the wand to the ladder cord or to the slat.

In embodiments, the clip connects to the wand at a point away from the mounted end.

The clip may permit rotation of the wand when installed. The clip may be removably attached to the wand.

In embodiments where the clip connects to the slat, the clip may have a magnetic link.

The clip may include a first body and a second body. The magnetic link may comprise a ball and a roller. The ball may have a circular cross section and may be affixed to the first body. The roller may have a circular cross section and may be affixed to the second body. The ball and the roller comprise magnetic materials, such as a magnet and a ferromagnetic pole piece attracted to the magnet. When the ball is in contact with the roller, an adjustment of the angle of the slat causes the ball to move with respect to the roller. The ball and roller may remain in contact so that the wand continues to be retained even if the slat angle is adjusted.

### BRIEF DESCRIPTION OF THE DRAWINGS

FIG. 1a shows a perspective view of a prior art blind.

FIG. 1b shows an enlarged detail perspective view of a portion of FIG. 1a.

FIG. 2 shows a perspective view of a first embodiment of a clip of the invention.

FIG. 3 shows a perspective view of a portion of a blind including the clip of the first embodiment.

FIG. 4 shows a perspective view of a second embodiment of a clip of the invention.

FIG. 5 shows a perspective view of a portion of a blind including the clip of the second embodiment.

FIG. 6 shows a perspective view of a third embodiment of a clip of the invention.

FIG. 7a shows a first perspective view of a portion of a blind including the clip of the third embodiment with the blind in an open position.

FIG. 7b shows an enlarged detail perspective view of a portion (circled) of FIG. 7a.

FIG. 8a shows a second perspective view of a portion of a blind including the clip of the third embodiment with the blind in a closed position.

FIG. 8b shows an enlarged detail perspective view of a portion (circled) of FIG. 8a.

### DETAILED DESCRIPTION

The invention includes blinds and clips as accessories for blinds.

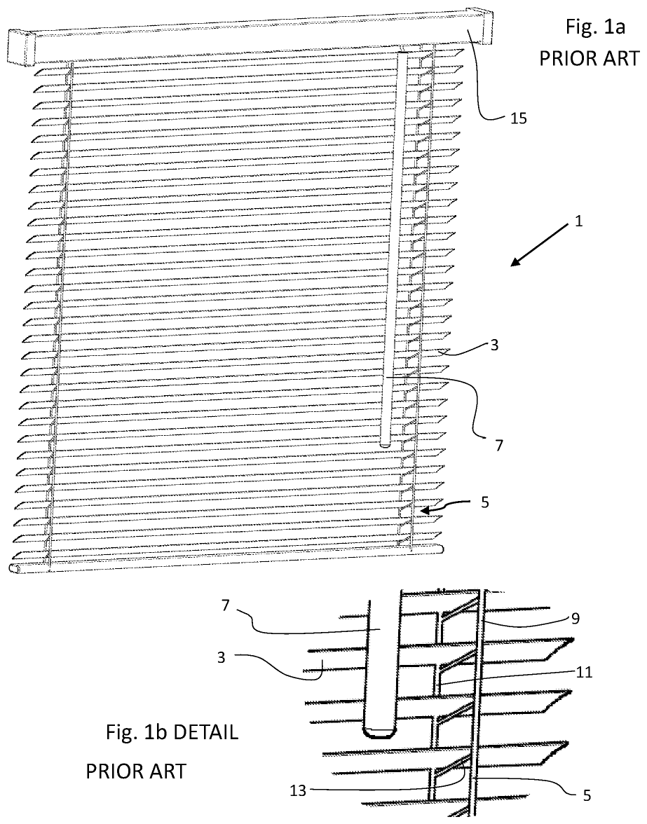

FIGS. 1a and 1b show prior art blinds. FIG. 1a shows an entire blind. FIG. 1b shows a portion surrounding the free end of the wand of the blind of FIG. 1a. This is enlarged to more clearly depict details. Blind 1 is usually mounted adjacent a vertically disposed window (not shown). Blind 1 includes a plurality of slats 3, ladder cords 5, wand 7, and support 15. Slats 3 are disposed generally horizontally and are supported by ladder cords 5.

Generally, more than one ladder cord 5 support slats 3 at separated locations across the width of blind 1. Wand 7 includes an elongated rod that attaches at one end to support 15. A free end 17 of wand 7 depends downward when blind 1 is installed. Wand 7 may be rotated about its long axis to adjust the angle of slats 7. Blind 1 has a support 15 usually located at the top of blind 1 from which wand 7, ladder cords 5, and (indirectly) slats 3 depend. A mechanism in support 15 converts the axial rotation of wand 7 to changes in the relative position of slats 3 through adjustment to ladder cords 5.

Ladder cords 5 include one or more vertically disposed parallel cords 9 and 11 with a plurality of cross cords 13 connecting parallel cords 9 and 11 at selected intervals. Rotation of wand 7 raises one of parallel cords 9 and 11 relative to the other parallel cord, so that cross cords 13 are disposed at an increased or decreased angle with respect to the window. Slats 3 rest on cross cords 13 so that the angle of cross cords 13 with respect to the window similarly increases or decreases.

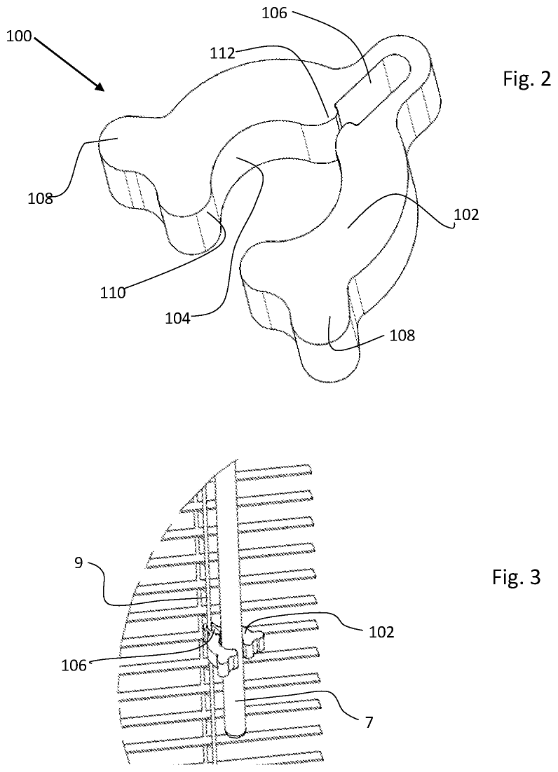

Referring to FIGS. 2 and 3, a first embodiment of the invention includes a clip 100 for use with a blind 1 and a blind with the clip installed. The description uses the same item numbers as those above to refer to the parts of a blind for clarity.

Clip 100 comprises a formed body 102 of a resilient substance such as plastic, wood, metal, or some combination. Resiliency of body 102 is useful because it permits a least a slight expansion of expansion recesses formed in clip 100 so that blind components may be inserted.

The resilience of body 102 allows body 102 to recover close to its initial geometry once blind components are inserted so that the components may be retained.

Body 102 may exert friction against retained blind components (particularly one of parallel cords 9 and 10) to prevent components from shifting by large amounts. This advantageously anchors clip 100 to a chosen location on blind 1.

Clip 100 may be formed by a number of processes known in the art. For example, clip 100 may be injection molded, machined, or produced by additive manufacturing methods such as three-dimensional printing. Alternatively, clip 100 may be punched or cut from a planar stock such as a foamed plastic sheet. 1 have found that effective and durable examples of clip 100 may be readily formed by fused deposition modeling using ABS, PLA, polyolefin, or other plastics known in the art.

Clip 100 includes a wand recess 104 defined within body 102 to retain wand 7 of blind 1. Wand recess 104 is sized to fit wand 7 but, in some embodiments might be slightly large so that wand 7 is free to rotate within wand recess 104. This advantageously allows adjustment of the blind 1 without removing wand 7 from wand recess 104.

Clip 100 also includes a cord recess 106 defined within body 102 to retain a cord such as one or more of parallel cords 9 and 11 of blind 1. Cord recess 106 might alternatively retain another cord, such as one of cross cords 13 or a cord used to raise and lower the entire blind 1.

The description of the embodiments that follow uses parallel cord 9 to indicate a cord retained in a clip, but it is expressly within the scope of the invention that any of these cords or a combination of them may be used in place of parallel cord 9.

Cord recess 106 is sized to fit and grip parallel cord 9. This advantageously holds clip 100 at a close to constant height in blind 1 even though wand recess 104 may allow wand 7 to freely rotate or to slide up or down. The height is “close to constant” because adjustments to the slat angle of blind 1 may cause small height changes in the position of parallel cord 9. Some blinds may include a third parallel cord in each ladder cord set that pierces slat 3 and may not change position when blind 1 is adjusted. In some embodiments, cord recess 106 may retain such a “neutral position” parallel cord.

Clip 100 may also include a wand entry location 110. Wand entry location 110 comprises an opening defined in body 102 of clip 100. Wand entry location 110 communicates with wand recess 100 but may have a width smaller than the diameter of wand 7. In other embodiments, wand entry location 110 may be absent: in such embodiments wand 7 may enter wand recess 104 by inserting the free end of wand 7 through wand recess 104. Wand 7 may also be inserted in this manner in embodiments that include wand entry location 110.

Wand entry location 110 may include a taper, such as a filleted or chamfered boundary as illustrated in FIG. 2. In use, a user may push the side (along the diameter of wand 7) of wand 7 against the taper towards wand recess 104. Compliance in the material of body 102 allows transient expansion of wand entry location 110 so that the extent of wand entry location 110 exceeds a diameter of wand 7. Wand 7 may then be pushed fully within wand recess 104. This entry removes the force to expand wand entry location 110 so that the resilient nature of body 102 restore the width of wand entry location 110 to close to its original size.

In some embodiments, clip 100 includes an expansion feature 108 formed from body 102. Expansion feature 108 may include one or more projections to enable a user to apply a force across wand entry location 110. Application of such a force causes a transient expansion of wand entry location 110 so that the extent of wand entry location 110 exceeds a diameter of wand 7.

Wand 7 may then be pushed fully within wand recess 104. The user may then release the force applied to expansion feature 108 so that the resilient nature of body 102 restore the width of wand entry location 110 to close to its original size. Expansion feature 108 advantageously applies leverage to reduce the peak force required to insert blind components into clip 100.

In some embodiments, a user may combine the two methods of applying pressure to expand wand entry location 110. A user could push wand 7 against a taper of wand entry location 110 while simultaneously applying force to one or more of expansion feature 108.

In some embodiments a pair of expansion features 108 may be present. In others, only one expansion feature 108 may be included.

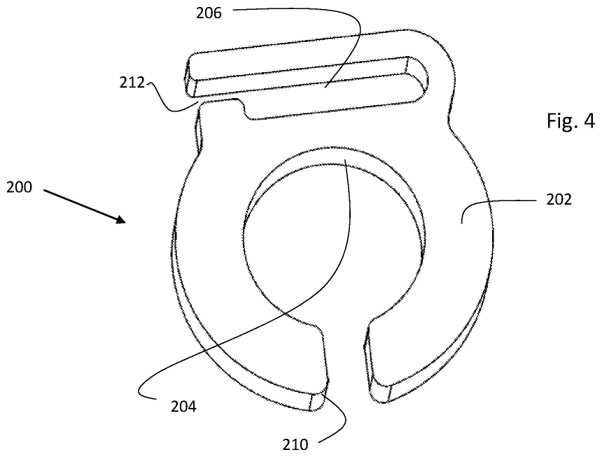

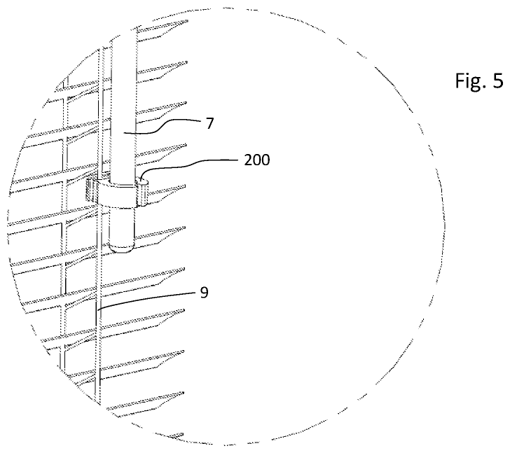

Similarly, clip 100 may also include a cord entry location 112. Cord entry location 112 also comprises an opening defined in body 102 of clip 100. Cord entry location 112 communicates with cord recess 106 but may be smaller than the diameter of parallel cord 9. In some embodiments (such as that illustrated in FIG. 2), cord entry location 112 communicates between cord recess 106 and wand recess 104. In other embodiments (such as that illustrated in FIG. 4), cord entry location 112 may communicate directly with the exterior of clip 100.

Cord entry location 112 may include a taper facing away from cord recess 106. Such a taper may include a filleted (as illustrated) or chamfered boundary. In use, a user may push the parallel cord 9 against the taper towards cord recess 106. Compliance in the material of body 102 allows transient expansion of cord entry location 112 so that the extent of cord entry location 112 exceeds a diameter of parallel cord 9. Parallel cord 9 may then be pushed fully within cord recess 106. This entry removes the force to expand cord entry location 112 so that the resilient nature of body 102 restore the width of cord entry location 112 to close to its original size.

Alternatively, in embodiments such as that illustrated in FIG. 1 where cord recess 106 communicates with wand recess 104, user application of force to expansion feature 108 may also expand cord entry location 112 so that parallel cord 9 may be simply inserted into cord recess 106. Release of the force allows the resilient nature of body 102 restore the width of cord entry location 112 to close to its original size.

In other embodiments (not shown), where a cord recess communicates directly with the with the exterior of clip 100, one or more expansion features similar to that described above may be present to aid in positioning parallel cord 9 in the cord recess.

FIG. 3 illustrates a blind with a clip 100 installed. Wand 7 is retained in wand recess 104 so that body 102 substantially envelops most of the circumference of wand 7. Parallel cord 9 is captured in cord recess 106. Parallel cord 9 may be raised or lowered to adjust the blind. Clip 100 maintains its position with respect to parallel cord 9 since the cord is tightly held in cord recess 106. Clip 100 moves upwards or downwards with respect to wand 7 as blind 1 is adjusted because the size of wand recess 104 may be larger than the diameter of wand 7 producing a loose fit between the parts. The loose fit also allows wand 7 to be freely rotated about its long axis to adjust the blind. Advantageously, wand 7 is retained in proximity to parallel cord 9 by clip 100 so that breezes cannot cause wand 7 to blow about.

Referring to FIGS. 4 and 5, another embodiment accomplishes similar results with a different structure. Clip 200 includes a body 202 defining independent wand recess 204 and cord recess 206. Cord recess 206 communicates with the outside of clip 200 through cord entry location 212. Cord entry location 212 includes a taper such as a fillet or chamfer facing away from cord recess 206. As described above, wand 7 may enter wand recess 206 by applying force across the diameter of wand 7 to the taper of wand entry location 210 to expand wand entry location 210 so that wand 7 may enter wand recess 204 from the side. Alternatively, a user may thread the free end of wand 7 through wand recess 206. Parallel cord 9 may enter cord recess 206 by applying a force through parallel cord 9 against the taper. Parallel cord 9 may then be pushed fully within cord recess 206. This entry removes the force to expand cord entry location 212 so that the resilient nature of body 202 restore the width of cord entry location 212 to close to its original size. Although this embodiment does not include expansion features on either of wand recess 204 of cord recess 206, such features may be present in related embodiments.

FIG. 5 shows the clip embodiment of FIG. 4 applied to a blind 1. Like the embodiment of FIG. 2, wand 7 is retained in wand recess 204 so that body 202 substantially envelops most of the circumference of wand 7. Parallel cord 9 is captured in cord recess 206. Parallel cord 9 may be raised or lowered to adjust the blind. Clip 200 maintains its position with respect to parallel cord 9 since the cord is tightly held in cord recess 206. Clip 200 moves upwards or downwards with respect to wand 7 as blind 1 is adjusted because the size of wand recess 204 may be larger than the diameter of wand 7 producing a loose fit between the parts. The loose fit also allows wand 7 to be freely rotated about its long axis to adjust the blind. Advantageously, wand 7 is retained in proximity to parallel cord 9 by clip 200 so that breezes cannot cause wand 7 to blow about.

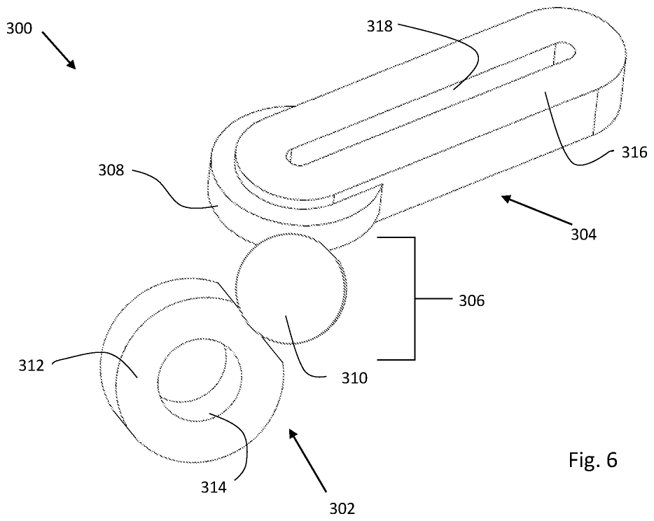

FIGS. 6-8 show other embodiments. Referring to FIGS. 6-8, clip 300 comprises two separable parts: wand holder 302 and slat holder 304. Wand holder 302 and slat holder 304 are removably connected by magnetic link 306. Magnetic link 306 comprises two parts that are magnetically attracted to one another. The two parts, slat piece 308 and wand piece 310, may each be hard coupled respectively to slat holder 304 and wand holder 302. Slat piece 308 and wand piece 310 are formed of magnetic materials including at least one magnet, which may be in either of the two parts. The second part may also be a magnet or may be a ferromagnetic pole piece that is attracted to the magnet. Slat piece 308 and wand piece 310 are held in contact with one another by the magnetic force.

Slat piece 308 and wand piece 310 may each have a circular cross section so that the parts may remain in contact by rolling with respect to one another as the relative position of wand holder 302 and slat holder 304 changes during blind adjustment. In some embodiments, slat piece 308 is approximately cylindrical and wand piece 310 is approximately spherical. This advantageously allows the parts to remain in rolling contact as the parts move with respect to each other through two degrees of freedom.

Wand holder 302 may be formed of a first body 312 defining a round wand aperture 314 sized to retain wand 7. Wand aperture 314 pierces through first body 312. In embodiments, wand aperture 314 may be slightly larger than the diameter of wand 7 so that wand 7 may be rotated about its long axis to permit blind adjustment. Wand holder 302 further includes wand piece 310 as described above.

Slat holder 304 may be formed of a second body 316 defining an elongated slat aperture 318 sized to retain slat 3 of blind 1. Slat aperture 318 pierces through second body 318.

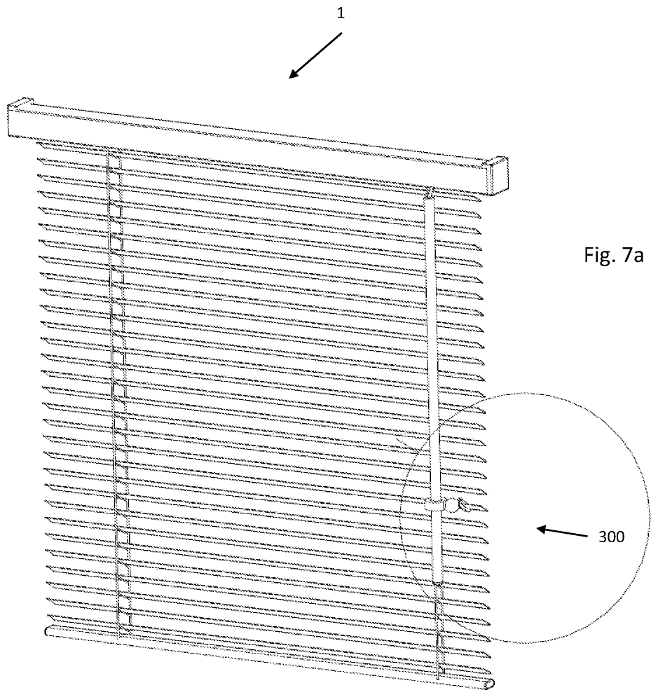

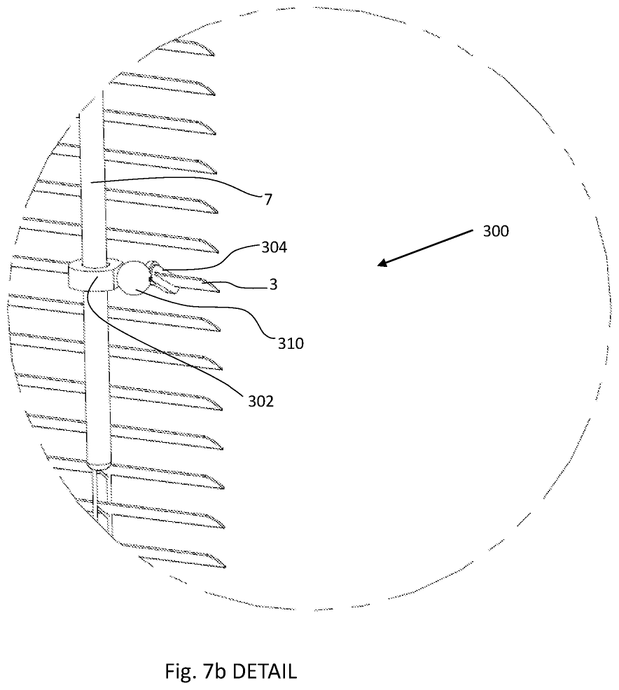

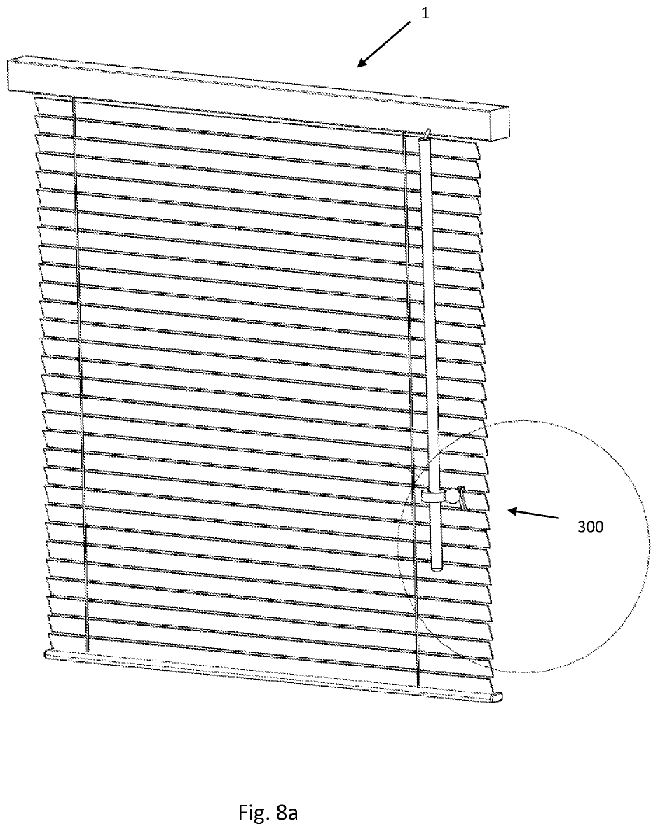

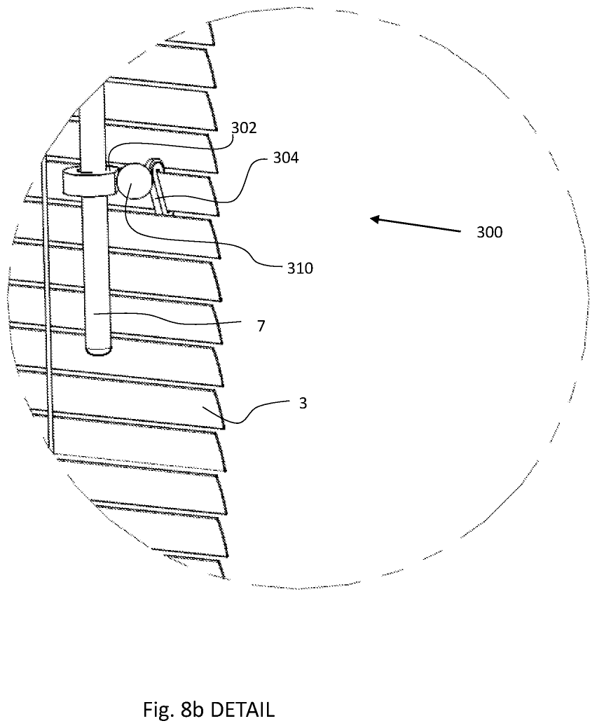

In use, an end of slat 3 of blind 1 may be inserted through slat aperture 318 to couple clip 300 to slat 3 as illustrated in FIGS. 7-8. FIG. 7a shows blind 1 in an open position; FIG. 8a shows blind 1 in a closed position. Details FIGS. 7b and 8b show enlarged views of the engagement of clip 300 to slats 3 in the two different positions of blind 1. The free end of wand 7 may be threaded through wand aperture 314 to couple wand 7 to clip 300. Wand holder 302 and slat holder 304 may then be brought into proximity with one another by sliding the blind parts through their respective apertures. Once in proximity, wand holder 302 may be coupled to slat holder 304 through magnetic link 310 to complete installation.

Magnetic link 306 advantageously allows wand 7 to be coupled to slat 3, which may afford a more robust retention. FIG. 7 shows a blind 1 in a closed position with clip 300 installed.

FIG. 8 shows the same installation with the blind in a closed position. Note that magnetic link 306 accommodates the blind in both positions despite the fairly large change in orientation of the parts.

The embodiments described herein are referred in the specification as “one embodiment,” “an embodiment,” “an example embodiment,” etc. These references indicate that the embodiment(s) described can include a particular feature, structure, or characteristic, but every embodiment does not necessarily include every described feature, structure, or characteristic. Further, when a particular feature, structure, or characteristic is described in connection with an embodiment, such feature, structure, or characteristic may also be used in connection with other embodiments whether or not explicitly described.

Further, where specific examples are given, the skilled practitioner may understand the particular examples as providing particular benefits such that the invention as illustratively disclosed herein suitably may be practiced in the absence of any element which is not specifically disclosed herein or within that particular example.

It will be apparent to those of ordinary skill in the art that many modifications and variations of the described embodiment are possible in the light of the above teachings without departing from the principles and concepts of the disclosure as set forth in the claims.

Although the present disclosure describes certain exemplary embodiments, it is to be understood that such disclosure is purely illustrative and is not to be interpreted as limiting.

Consequently, without departing from the spirit and scope of the disclosure, various alterations, modifications, and/or alternative applications of the disclosure will, no doubt, be suggested to those skilled in the art after having read the preceding disclosure. Accordingly, it is intended that the following claims be interpreted as encompassing all alterations, modifications, or alternative applications as fall within the true spirit and scope of the disclosure.

I claim:

1. A clip for use with an adjustable slat blind that includes a ladder cord and an elongated wand that adjusts a position of a slat, the clip comprising:
a compliant body;
a first recess to retain a wand of the blind, the first recess defined within the compliant body;
a second recess to retain a ladder cord of the blind, the second recess defined within the compliant body; and
an expansion feature,
wherein application of a force to the expansion feature expands the first recess so that the wand may enter the first recess, and wherein the compliant body recovers upon release of the force to restore the first recess so that the wand is retained therein.

2. The clip of claim 1, wherein the wand is free to rotate when retained within the first recess.

3. The clip of claim 2, wherein the first recess has an inside diameter and the wand has an outside diameter, the inside diameter larger than the outside diameter.

4. The clip of claim 1, wherein the first recess is contiguous with the second recess.

5. A clip for use with a blind that includes a slat, a ladder cord, and an elongated wand that adjusts an angle of the slat, the clip comprising:
a first body including a first aperture sized to retain a wand of a blind;
a second body including a second aperture sized to retain a slat of the blind; and
a magnetic link configured to removably couple the first body to the second body.

6. The clip of claim 5, wherein the first aperture has an inside diameter and the wand has an outside diameter, the inside diameter larger than the outside diameter so that the wand is free to rotate when retained within the first aperture.

7. The clip of claim 6, wherein the magnetic link comprises a ball and a roller, the ball having a circular cross section affixed to the first body, and the roller having a circular cross section affixed to the second body, the ball and the roller comprising magnetic materials and the ball in contact with the roller, wherein an adjustment of the angle of the slat causes the ball to move with respect to the roller.

8. A blind comprising:
a support;
a ladder cord depending from the support and including a first vertical cord, a second vertical cord parallel to the first vertical cord, and a cross cord connecting the first vertical cord to the second vertical cord;
a slat supported by the ladder cord;
an elongated wand having a mounted end depending from the support, the wand configured to alter the relative position of the first vertical cord with respect to the second vertical cord by rotation of the wand; and
a clip connecting the wand to the ladder cord or to the slat.

9. The blind of claim 8, wherein the clip connects to the wand at a point away from the mounted end.

10. The blind of claim 9, wherein the clip permits rotation of the wand.

11. The blind of claim 10, wherein the clip is removably attached to the wand.

12. The blind of claim 11, wherein the clip connects to the slat, and wherein the clip includes a magnetic link.

13. The blind of claim 11, wherein the clip comprises a first body and a second body, and wherein the magnetic link comprises a ball and a roller, the ball having a circular cross section affixed to the first body, and the roller having a circular cross section affixed to the second body, the ball and the roller comprising magnetic materials and the ball in contact with the roller, wherein an adjustment of the angle of the slat causes the ball to move with respect to the roller.
